(19) United States
(12) Patent Application Publication
(10) Pub. No.: US 2013/0311449 A1
(43) Pub. Date: Nov. 21, 2013

(54) Identifying Referred Documents Based on a Search Result

(71) Applicant: INTERNATIONAL BUSINESS MACHINES CORPORATION, Armonk, NY (US)

(72) Inventors: Barry A. Kritt, Raleigh, NC (US); Sarbajit K. Rakshit, Kolkata (IN)

(73) Assignee: INTERNATIONAL BUSINESS MACHINES CORPORATION, Armonk, NY (US)

(21) Appl. No.: 13/764,785

(22) Filed: Feb. 12, 2013

Related U.S. Application Data
(63) Continuation of application No. 13/472,218, filed on May 15, 2012.

(51) Int. Cl. G06F 17/30

(52) U.S. Cl. CPC G06F 17/30554
USPC 707/722

(57) ABSTRACT

Referred documents are identified, based on search results. When search results are obtained responsive to a search query, information corresponding to one or more documents that match the search query is displayed. A user may then perform a user gesture, such as a hover operation, in association with the displayed information corresponding to any particular one of the matching documents. Responsive to the user gesture, one or more other documents are determined, each of these other documents referring to the particular one of the matching documents, and information corresponding to each of the other documents is displayed for the user. Preferably, the referring comprises an embedded reference, within each other document, to the Uniform Resource Locator (“URL”) at which the particular one of the matching documents is stored. The user can then select one of the other documents from the display.

### BACKGROUND

The present invention relates to computing systems, and deals more particularly with searches that use computing systems to identify network-accessible documents. Still more particularly, the present invention relates to identifying one or more documents in which another document is referenced, and providing for convenient selection of any of those one or more documents.

When a user is viewing a network-accessible document (such as a Web page), one or more hyperlinks may appear in the viewed document. As is readily understood, a hyperlink can be activated to view a linked, or referenced, document. If a viewed document is termed “document A” and contains a hyperlink to a “document B”, for example, then clicking on the hyperlink with a mouse pointer or otherwise activating the hyperlink will result in retrieval and display of document B. The hyperlink itself may be displayed using any text selected by the author of the viewed document, and operates to retrieve the referenced document through a corresponding Uniform Resource Locator (“URL”) that is specified within the source code of the viewed document, the URL comprising a network address of the referenced document.

### BRIEF SUMMARY

The present invention is directed to identifying linked documents, based on a search result. In one aspect, this comprises: performing a search of network-accessible documents using a search query; displaying search results identifying a plurality of the network-accessible documents that match the search query, responsive to the performing; responsive to a user gesture performed in association with a particular one of the identified documents, determining at least one other network-accessible document that contains an embedded hyperlink to a location at which the particular identified document is stored; and displaying, in a window, descriptive information for each of the at least one other network-accessible document, the descriptive information comprising at least a selectable link. The user gesture may comprise hovering a mouse cursor or other selection means over a display corresponding to the particular one of the identified documents. Each of the at least one selectable link is preferably selectable, from the window, to cause display of corresponding content that refers to the particular one of the identified documents. In another aspect, the processing need not originate from a search result display, and instead may be initiated from a view of document.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 depicts an example of content that might be viewed by a user from a network-accessible document;

FIG. 2 shows a sample URL and document title, which are used to illustrate the functioning of a hyperlink in the document shown in FIG. 1;

FIG. 3 provides a sample markup language document containing source code that corresponds to the viewed document of FIG. 1, where this source code includes an embedded URL that serves as the address for retrieving a hyperlinked document;

FIG. 4 provides an example of a search query to search for network-accessible documents, and FIG. 7 illustrates sample URLs;

FIG. 5, comprising FIGS. 5A-5C, provides an example display for a search result, a user gesture (such as a hover operation) to select a document from the search result, and an additional window displayed in response to the user gesture, respectively;

FIG. 6 provides a flowchart depicting logic which may be used when implementing an embodiment of the present invention;

FIG. 8 depicts a data processing system suitable for storing and/or executing program code; and

FIG. 9 depicts a representative networking environment in which one or more embodiments of the present invention may be used.

### DETAILED DESCRIPTION

The present invention is directed to identifying one or more documents where another document is referenced, and providing for convenient selection of any of those one or more documents. The selection is facilitated by displaying information pertaining to the identified documents, where this displayed information is selectable by a user, as will now be described.

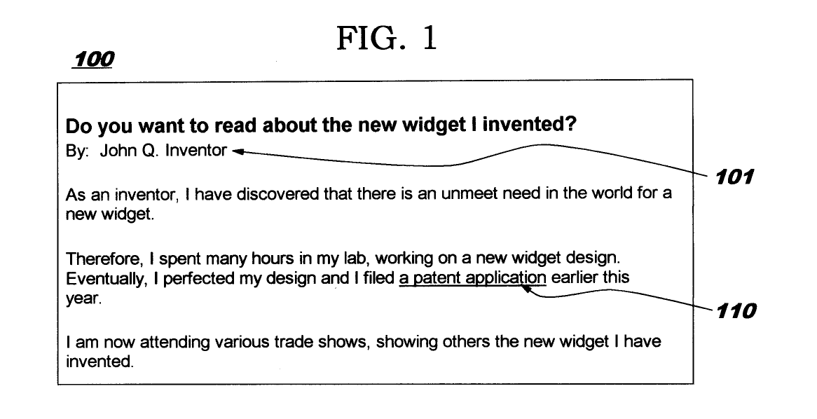

FIG. 1 shows an example of content of a network-accessible document 100 that might be viewed by a user. (Network-accessible documents are also referred to herein, for ease of reference, simply as documents). In this example, the document 100 is a news article that discusses a patent application, and a hyperlink 110 has been provided within the display of this news article. In this example, the hyperlink 110 is operable to cause retrieval of a particular document that discusses the patent application—that is, a document that is different from the currently-viewed document 100.

As is well known, the presence of a hyperlink within a viewed document may be indicated visually with various approaches. Commonly, some portion of the text in the viewed document may be rendered in a distinctive color and/or with an underlined font, for example, to convey to the user that there is a hyperlink at this location within the viewed document. For drafting convenience, hyperlinks are illustrated in the accompanying drawings using underlining. Thus, it can be seen in FIG. 1 that a hyperlink 110 can be activated from the text string “a patent application” that is part of the content of document 100.

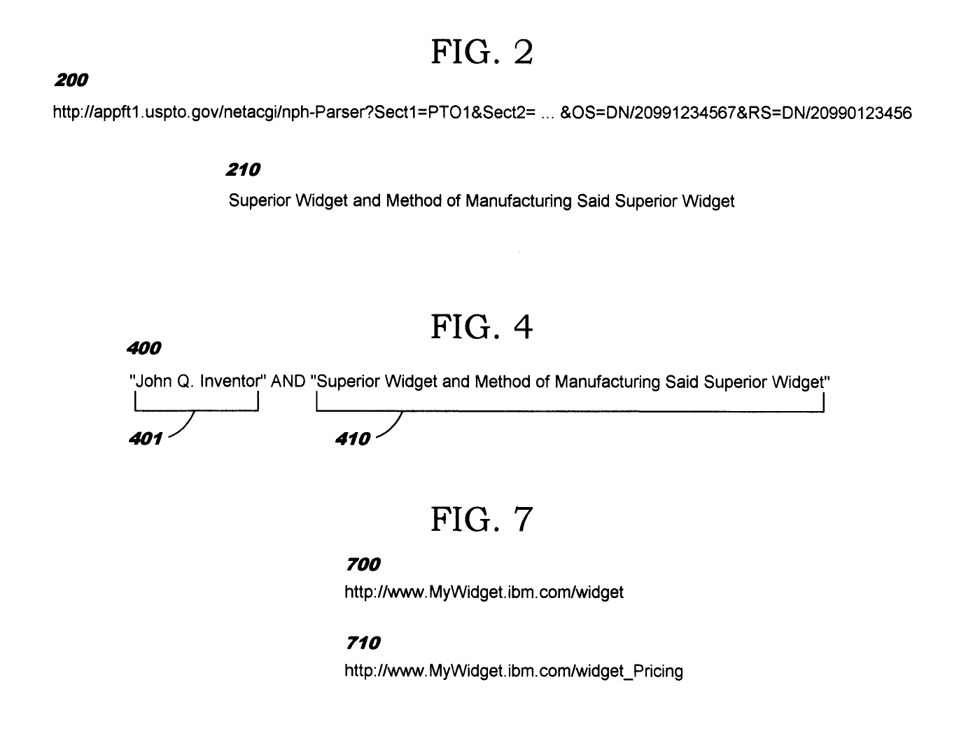

Suppose, by way of example, that the document which is retrieved by activating the hyperlink 110 is a patent publication document created by the United States Patent and Trademark Office, where the author of document 100 has provided the URL of this patent publication document in the source code for document 100 so that a user viewing document 100 can easily retrieve a copy of the patent publication document. A hypothetical example of the URL of the patent publication document is shown at 200 in FIG. 2, and a sample title for the patent publication document is shown at 210 in FIG. 2.

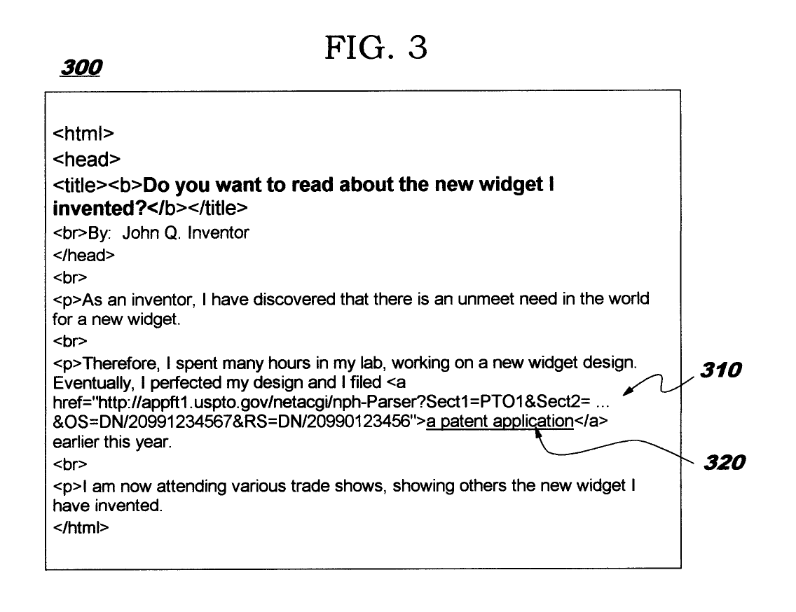

FIG. 3 shows a sample markup language document 300 containing source code that corresponds to the viewed document 100 of FIG. 1, where this source code includes an embedded URL 310 that serves as the address for retrieving a hyperlinked document. In this example, a hypothetical URL is shown at 310 as the value of the “href” attribute on the “<a>” (i.e., anchor) tag, and this URL 310 (which is identical to URL 200) is the link with which the above-discussed patent publication document can be retrieved responsive to a user activating the hyperlink 110 of FIG. 1. In this example, the text at 320 indicates the displayable content of viewed document 100 that will serve as the selectable text of hyperlink 110, from which the user can activate the hyperlinked document retrieval. (The syntax and structure of the source code in markup language documents such as document 300 of FIG. 3 is readily understood by those of ordinary skill in the art, and will therefore not be discussed in detail herein.)

As is readily understood by those of ordinary skill in the art, when a user performs a search of network-accessible documents, results of the search are typically displayed as a list of descriptive information pertaining to each of a plurality of documents matching the search query and a corresponding selectable link with which each of these documents can be accessed. The selectable links are typically presented as URLs and the corresponding descriptive information is aimed at guiding the user in choosing which of the links to access. The search results are typically ordered according to an expected relevance of the located documents to the search query. These concepts are readily understood by those of ordinary skill in the art. As is also readily understood, a user who is viewing the search results might select one or more of the selectable links, in turn, to peruse selected ones of the documents that are accessible from the selectable links.

Referring again to the example illustrated in FIGS. 1 and 2, note that the author of document 100 is John Q. Inventor (see 101) and that the title of the document stored at URL 200 and linked from document 100 at hyperlink 110 is “Superior Widget and Method of Manufacturing Said Superior Widget” 210. Suppose that a user had not yet found the document 100, and instead was searching for that information (and perhaps for related information as well) using an Internet search. Further suppose that the user knows that John Q. Inventor has written a news article about his patent application (namely, the document 100 of FIG. 1) and knows the title 210 of the patent application, but does not know the URL 200 by which the news article can be accessed. Known techniques do not provide a way to locate document 100 using the two values 101, 210 as terms in a search query because, as can be seen by review of document 100 (and its underlying source code 300 of FIG. 3), the title 210 of the linked document does not appear anywhere within the content of document 100. See FIG. 4, where a search query 400 formed from values 101, 210 (indicated by reference numbers 401, 410, respectively) is depicted. A search using this query 400 might return an error message and/or empty set of results, but notably, will not locate document 100 of FIG. 1 even though document 100 contains the text 401 and a reference (i.e., by hyperlink 110) to a document which has title 410.

More generally, suppose a user performs an Internet search for a topic “T”, and that the search locates a set of first documents FD1, FD2, . . . , FDN as matching the search query and thus potentially being of interest to the user in view of this search. Further suppose that the user is interested in the content of the located first document FD3 from the search result display. Known techniques do not provide a way to conveniently find other second documents SD1, SD2, . . . , SDN that refer to the selected first document FD3. (The terms “first document” and “second document”, or plural forms thereof, are used herein to distinguish among documents located responsive to a search query and documents which refer to a document located by such search query, respectively.) More particularly, known techniques do not provide a convenient way to find such other second documents SD1, SD2, . . . , SDN from the search result display where selectable links to first documents FD1, FD2, . . . FDN are displayed.

According to an embodiment of the present invention, when a user performs an Internet search and one or more first documents FD1, FD2, . . . FDN are located in response, the user can conveniently locate other second documents SD1, SD2, . . . , SDN that refer to any user-selected one of the located first documents—and notably, such second documents SD1, SD2, . . . , SDN can be located even if the reference in the second document is simply a hyperlink to the user-selected first document. It should be noted that an embodiment of the present invention does not require the user to actually select, or view, the first document that is of interest. Preferably, the user who is viewing search results performs a user gesture over, or in association with, the displayed information corresponding to one of the first documents FD1, FD2, . . . FDN which is currently viewable in the search results. For example, the user may hover a cursor or other selection means over a displayed description of a particular one of first documents FD1, FD2, . . . FDN or over the corresponding selectable link to that particular document. In response to this user gesture, an embodiment of the present invention automatically determines other second documents SD1, SD2, . . . SDN that refer to the user-selected first document from the search results. A window is then displayed, on the same graphical user interface (“GUI”) space where the search results FD1, FD2, . . . FDN are displayed, and selectable links L1, L2, . . . LN corresponding to the automatically-determined second documents SD1, SD2, . . . SDN are shown in this newly-displayed window. Descriptive information pertaining to each second document is also preferably shown in the newly-displayed window, along with the corresponding selectable link, to aid the user in determining which second document may be of interest. (A second documents may also be termed a “referring document” because it refers to the user-selected first document.)

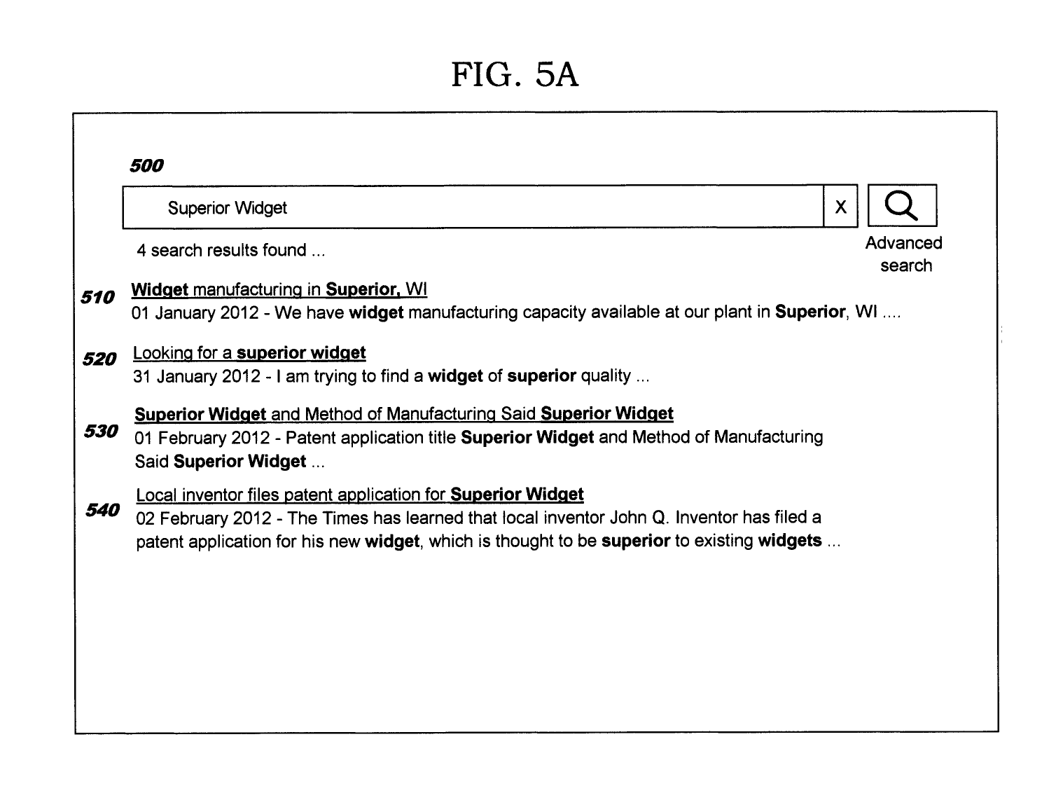

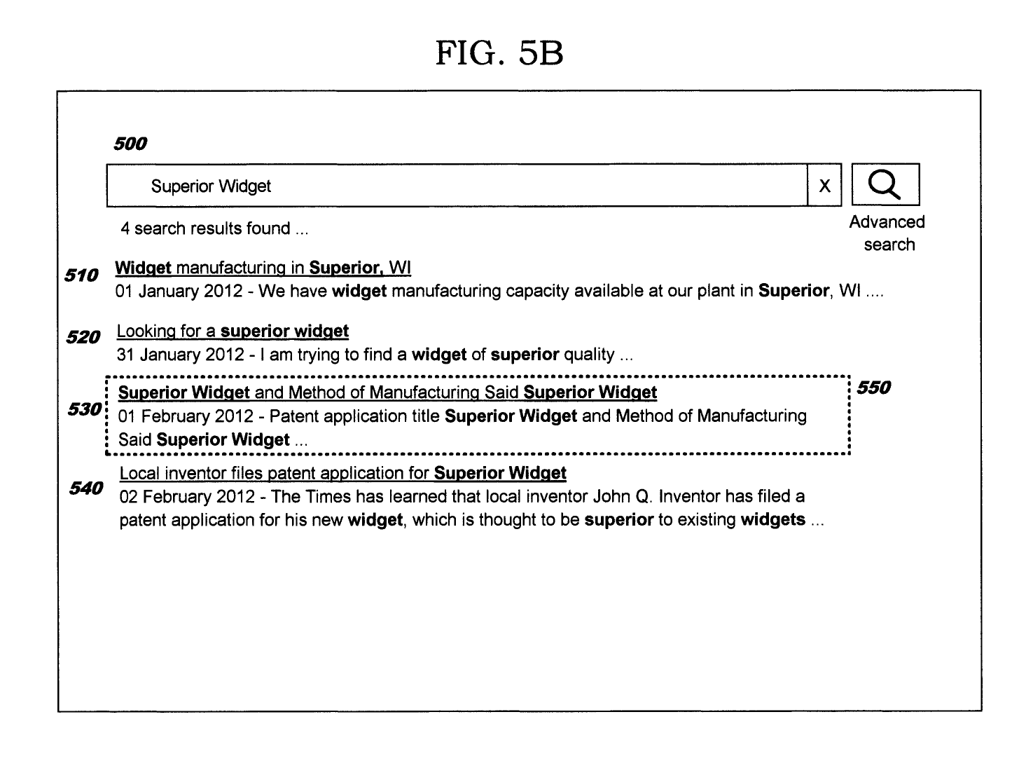

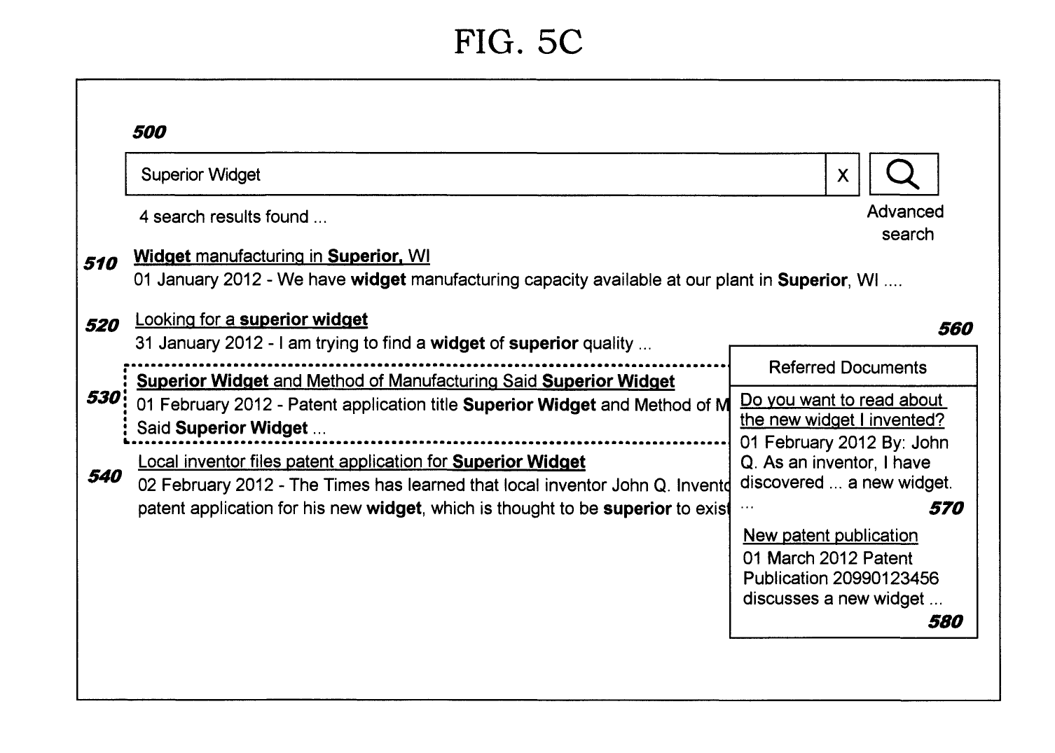

An example display for a set of search results containing first documents FD1, FD2, . . . FDN is provided in FIG. 5A. In this example, the user entered the search query “Superior Widget”, as shown at 500, and 4 first documents 510, 520, 530, 540 were located by searching the Internet using this query. Now suppose that the user performs a user gesture—such as hovering a mouse cursor—over the displayed document information at 530. This user gesture is shown by highlighting 550 in FIG. 5B (where a dashed rectangle is shown at 550 to indicate highlighting, for drafting convenience). In response, an embodiment of the present invention automatically determines one or more referring documents that each refer to document 530, and a window is automatically added to the GUI to display corresponding information and selectable links to these referring documents, as shown by window 560 in FIG. 5C. In the example, window 560 provides document information and selectable links for two such referring documents, as shown at 570, 580. The user can thus conveniently select the link for a referring document 570, 580 to display the corresponding referring document. Advantageously, the referring documents 570, 580 are located by an embodiment of the present invention even though the content of the referring document does not necessarily contain text of the document 530. Instead, referring documents 570, 580 may be located because each contains a hyperlink to the URL at which document 530 is located. Note, for example, that the descriptive information for referring document 570 is a representation of document 100 of FIG. 1, indicating that document 100 can be located by an embodiment of the present invention even though the search query 400 of FIG. 4 would fail to do so. It should also be noted that the referring documents 570, 580 may be presented to the user in window 560, and may be selected by the user from window 560, without the user needing to actually access any document 510, 520, 530, 540 from the original search.

Optionally, the list of referring documents presented in the window 560 may be sorted prior to display. This sort may be according to a degree of appropriateness, a social reputation score, a number of accesses of the corresponding document, and so forth. Degree of appropriateness for a referred document may be determined using conventional means, and represents how closely the referred document is thought to match the search query with which it was located. The social reputation score for a referred document is preferably a predetermined value that is stored in association with the document. It may indicate, for example, what types of users normally find this referred document interesting or useful, and for purposes of ordering the display in window 560, the predetermined social reputation score for each referring document may be compared to a social reputation score of the user who performs the user gesture at 530.

As another option, both referred-to and referred-from links can be shown responsive to a user gesture such as hovering a selection means over a displayed link in the search results. In this case, referred-to links are outbound links from the document corresponding to the hovered link, and referred-from links are inbound links to the document corresponding to the hovered link. With reference to FIG. 5, for example, the referred-from links for the document represented at 530 are the documents 570, 580 in window 560.

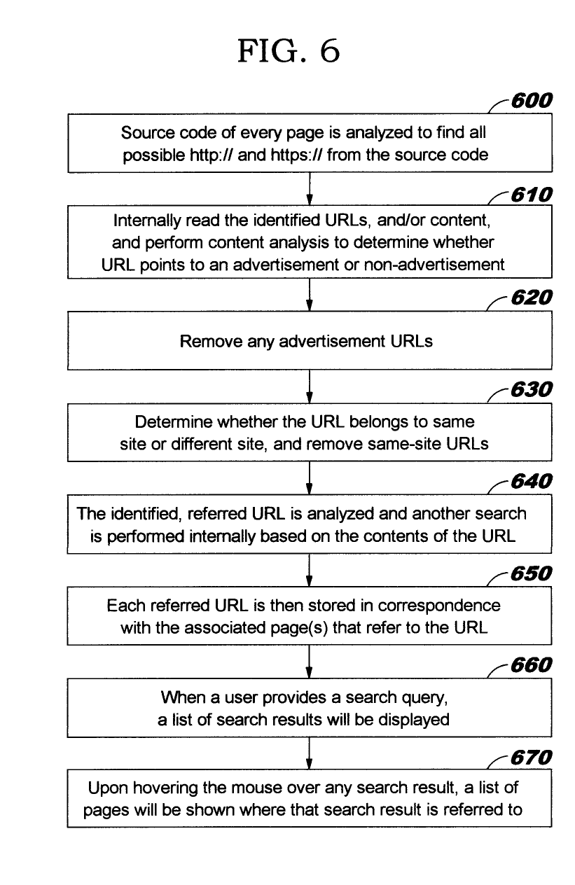

Turning now to FIG. 6, a flowchart is provided that depicts logic which may be used when implementing an embodiment of the present invention. This logic provides a preprocessing approach, whereby documents are analyzed in advance to determine their embedded hyperlinks The processing time required to obtain the list of referred documents in window 560 of FIG. 5C, relative to the time when a user enters a search query 500 of FIG. 5A, can thus be reduced.

Block 600 of FIG. 6 indicates that source code of web page documents is analyzed, searching for the presence of “http://” and “https://” character strings. As is readily understood by those familiar with URLs, these character strings form the initial part of a URL. Thus, presence of such character string in the source code of an analyzed web page document signifies that the beginning part of an embedded hyperlink has been found.

Block 610 performs a content analysis of the document stored at each located URL to determine whether the URL points to an advertisement. Preferably, a database is consulted that stores predetermined textual patterns which, when present within a document, indicate that the linked document is an advertisement. In addition or instead, the processing of Block 610 may comprise analyzing the URL itself, rather than the content of the corresponding document. In this case, patterns within the URL may be compared to known patterns, such as web sites that provide advertisements. Block 620 then removes any URL located at Block 600 which has been determined, by Block 610, to point to an advertisement. The processing of Blocks 610-620 seeks to improve user satisfaction by not “cluttering” the window 560 with links to advertisements (and may be omitted from an embodiment of the present invention without deviating from the inventive concepts disclosed herein).

Block 630 then determines, for each URL that remains after the filtering process of Blocks 610-620, whether this URL belongs to the same site or a different site. The processing of Block 630 also comprises removing any same-site URLs. This same-site versus different-site comparison is made with reference to the document in which the URL was located by Block 600. If a URL located within a particular document points to the same site, this may be simply a page navigation URL and not a hyperlink to a separately-stored document. For example, if a document stored at the URL 700 of FIG. 7 contains the embedded URL 710, then Block 630 will determine that URL 710 is a navigation link that points to the same site as URL 700 because the protocol string “http” and domain name “www.MyWidget.ibm.com” match in both of these URLs 700, 710 (and accordingly, Block 630 will remove URL 710 from further consideration).

For each URL that remains after the processing of Block 630, Block 640 performs an analysis to determine other documents where that URL is referenced. Preferably, this comprises performing a search process internally (i.e., without displaying results to a user) based on the contents of the URL. In Block 640, identifying information for web pages which are located using this internal search is then stored in a repository, such as a database, in correspondence with the URL. This repository is preferably maintained at (or otherwise accessible to) a service provider that is subsequently accessed when performing a search such as search query 500 of FIG. 5A.

With reference to the example discussed earlier, suppose that Block 600 is processing URL 200 of FIG. 2. Further suppose that Blocks 610-620 conclude that this is not a link to an advertisement, and thus URL 200 is not removed from the collection of URLs being processed. Block 640 then performs an internal search, based on the contents of the patent publication document stored at URL 200, and locates (in this example) two referring documents 570, 580 which contain URL 200 embedded within their source code (such as the embedded URL 310 in source code 300 of FIG. 3). Block 650 may then store the URL 200 as an index, or key, to a database entry, and may then set the value of that database entry to the URLs at which referring documents 570, 580 are located.

In Block 660, when a user subsequently provides a search query, a list of search results is displayed. This query is illustrated by query 500 of FIG. 5A, and the displayed list of search results is illustrated by 510, 520, 530, 540 of FIG. 5A. When the user then performs a user gesture, such as hovering a mouse cursor or other selection means over any of the displayed search results, Block 670 will automatically display a list of pages where that search result is referred to. The hover is illustrated at 550 in FIG. 5B, and the resulting list of referring pages is illustrated at 570, 580 in window 560 of FIG. 5C.

As can be seen, an embodiment of the present invention provides a convenient way for the user to explore documents which relate to some topic found within a document located by a search, where those documents refer to the located document using its hyperlink.

In an alternative aspect, the processing need not originate from a search result display, and instead may be initiated from a view of document. Suppose, for example, that the document located at URL 200 of FIG. 2 is displayed for a user. The user may then perform a user gesture to initiate a search for referring documents. The user gesture may comprise, for example, a right-click over the document display using a mouse cursor, hovering the mouse cursor over some portion of the document for a particular period of time, selecting a choice (such as “Find Referring Documents”) from a pop-up or pull-down menu, or other selection technique. In response, a search is preferably initiated to locate page information for the currently-viewed document. This page information preferably comprises the URL of the currently-viewed document and URLs (and corresponding information) of other referring documents—that is, documents that refer to the displayed document, for example by containing a hyperlink to the displayed document. A window such as window 560 of FIG. 5C is then preferably displayed, on the same GUI space with the document from which the user gesture was performed, and the user may then select one of these referring documents in the same manner discussed above.

With reference to the flowchart in FIG. 6, this logic may be adapted for use with an embodiment of this alternative aspect. Rather than providing a search query at Block 660 and performing a user gesture with response to the display of search query results at Block 670, the alternative aspect preferably uses a single document display at Block 660 (which may be thought of as results of a search for a topic T that corresponds to the displayed document and which has only one matching document) and Block 670 then represents the user gesture with reference to this single document display.

Optionally, an embodiment of the present invention may be configured for supporting searches for referring documents for both scenarios—that is, where the searches are initiated from first documents that are displayed in response to a search query and also where the searches are initiated from displays of single documents that were not located using search queries.

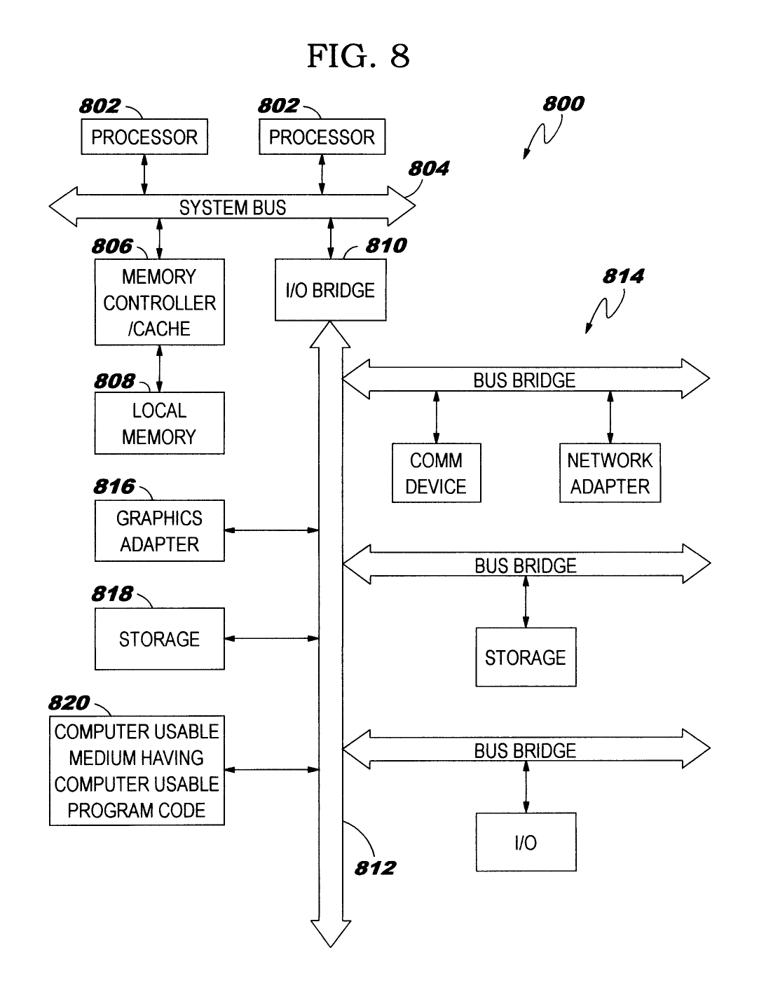

Referring now to FIG. 8, a block diagram of a data processing system is depicted in accordance with the present invention. Data processing system 800, such as one of the processing devices described herein, may comprise a symmetric multiprocessor (“SMP”) system or other configuration including a plurality of processors 802 connected to system bus 804. Alternatively, a single processor 802 may be employed. Also connected to system bus 804 is memory controller/cache 806, which provides an interface to local memory 808. An I/O bridge 810 is connected to the system bus 804 and provides an interface to an I/O bus 812. The I/O bus may be utilized to support one or more buses 814 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 816, storage 818, and a computer usable storage medium 820 having computer usable program code embodied thereon. The computer usable program code may be executed to execute any aspect of the present invention, as have been described herein.

The data processing system depicted in FIG. 8 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Oracle America, Inc., in the United States, other countries, or both.)

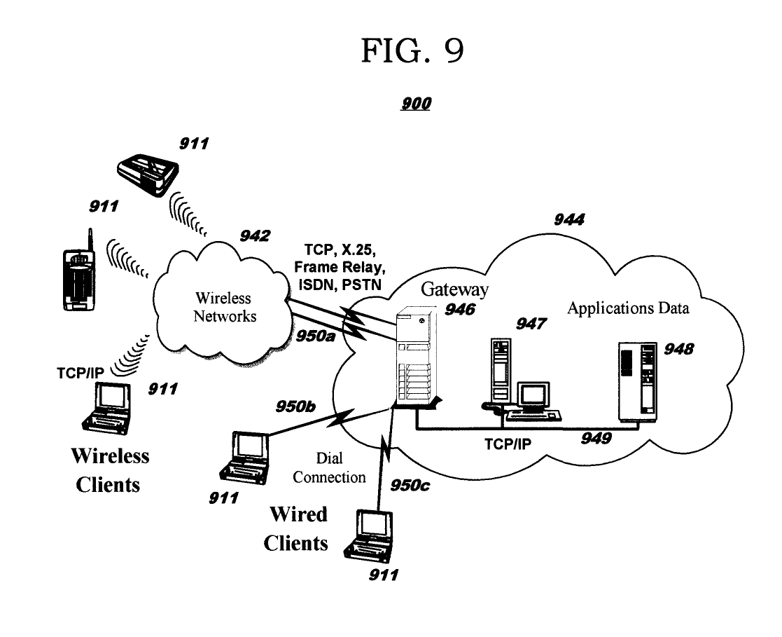

FIG. 9 illustrates a data processing network environment 900 in which the present invention may be practiced. The data processing network 900 may include a plurality of individual networks, such as wireless network 942 and wired network 944. A plurality of wireless devices 910 may communicate over wireless network 942, and a plurality of wired devices, shown in the figure (by way of illustration) as workstations 911, may communicate over network 944. Additionally, as those skilled in the art will appreciate, one or more local area networks (“LANs”) may be included (not shown), where a LAN may comprise a plurality of devices coupled to a host processor.

Still referring to FIG. 9, the networks 942 and 944 may also include mainframe computers or servers, such as a gateway computer 946 or application server 947 (which may access a data repository 948). A gateway computer 946 serves as a point of entry into each network, such as network 944. The gateway 946 may be preferably coupled to another network 942 by means of a communications link 950a. The gateway 946 may also be directly coupled to one or more workstations 911 using a communications link 950b, 950c, and/or may be indirectly coupled to such devices. The gateway computer 946 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 946 may also be coupled 949 to a storage device (such as data repository 948).

Those skilled in the art will appreciate that the gateway computer 946 may be located a great geographic distance from the network 942, and similarly, the workstations 911 may be located some distance from the networks 942 and 944, respectively. For example, the network 942 may be located in California, while the gateway 946 may be located in Texas, and one or more of the workstations 911 may be located in Florida. The workstations 911 may connect to the wireless network 942 using a networking protocol such as the Transmission Control Protocol/Internet Protocol (“TCP/IP”) over a number of alternative connection media, such as cellular phone, radio frequency networks, satellite networks, etc. The wireless network 942 preferably connects to the gateway 946 using a network connection 950a such as TCP or User Datagram Protocol (“UDP”) over IP, X.25, Frame Relay, Integrated Services Digital Network (“ISDN”), Public Switched Telephone Network (“PSTN”), etc. The workstations 911 may connect directly to the gateway 946 using dial connections 950b or 950c. Further, the wireless network 942 and network 944 may connect to one or more other networks (not shown), in an analogous manner to that depicted in FIG. 9.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of identifying referred documents based on search results, comprising:
performing a search of network-accessible documents using a search query;
displaying search results identifying a plurality of the network-accessible documents that match the search query, responsive to the performing;
responsive to a user gesture performed in association with a particular one of the identified documents, determining at least one other network-accessible document that contains an embedded hyperlink to a location at which the particular identified document is stored; and
displaying, in a window, descriptive information for each of the at least one other network-accessible document, the descriptive information comprising at least a selectable link.

2. The method according to claim 1, further comprising ordering the selectable links in the window when descriptive information for a plurality of the other network-accessible documents is displayed therein.

3. The method according to claim 2, wherein the ordering is according to a number of views of each of the other network-accessible documents.

4. The method according to claim 2, wherein the ordering is according to an appropriateness of each of the other network-accessible documents to the particular one of the identified documents.

5. The method according to claim 2, wherein the ordering is according to a social reputation score for each of the other network-accessible documents.

6. The method according to claim 1, wherein each of the at least one selectable link is selectable, from the window, to cause display of corresponding content without accessing the particular one of the identified documents from the search result.

7. The method according to claim 1, wherein each of the at least one selectable link is determined in a preprocessing operation that analyzes embedded hyperlinks in a collection of network-accessible documents.

8. The method according to claim 7, wherein the preprocessing operation filters out any hyperlinks that are determined, by content analysis, to refer to an advertisement document.

9. The method according to claim 7, wherein the preprocessing operation filters out any hyperlinks that are determined, by pattern matching, to refer to a same site as the network-accessible document in which the hyperlink is embedded.

10. The method according to claim 7, further comprising:
storing, in a repository, each selectable link determined by the preprocessing operation, in association with a key value corresponding to the location at which the particular identified document is stored; and
subsequently retrieving the selectable link for each of the at least one other network-accessible documents from the storage repository, using the location as the key value, when the user gesture is detected.

11. The method according to claim 1, wherein the user gesture comprises a hover operation.

12. The method according to claim 1, wherein each of the at least one selectable link is selectable, from the window, to cause display of corresponding content that refers to the particular one of the identified documents.
